(19) United States
(12) Patent Application Publication
(10) Pub. No.: US 2017/0197846 A1
(43) Pub. Date: Jul. 13, 2017

(54) WATER SOFTENING BALL FOR USE FOR A PET

(71) Applicant: Etec Inc., Tokyo (JP)

(72) Inventor: Shiro Ono, Tokyo (JP)

(73) Assignee: Etec Inc., Tokyo (JP)

(21) Appl. No.: 14/990,193

(22) Filed: Jan. 7, 2016

(51) Int. Cl. C02F 1/42; A01K 7/00

(52) U.S. Cl. CPC C02F 1/42; A01K 7/00; C02F 2101/206

(57) ABSTRACT

A water softening ball for use for a pet is provided, comprising a shell having a generally hollow ellipsoidal shape, wherein a plurality of openings are thrilled in the shell for the inside and the outside of the shell to communicate; and a filter unit included within the shell and comprising an ion exchange resin. The ellipsoidal shape includes a spherical shape.

### BACKGROUND

Dogs, cats, and humans alike can suffer from urinary calculi or stones, a dreaded buildup of irritating substances in the urinary tract that causes pain and even obstruction. Urolithiasis refers to calcifications that form in the urinary system, primarily in the kidney (nephrolithiasis) or ureter (ureterolithiasis), and may also form in or migrate into the, lower urinary system (bladder or urethra). The onset of these diseases is when the amount of minerals present in the wine is high enough that the minerals are unable to remain dissolved. Thus, prevention measures include proper diets to reduce the intake of such problem-causing minerals.

Water described as “hard” is high in dissolved minerals, specifically calcium and magnesium. Water supplied as tap water is hard or soft depending on regions, and hard water is normally harmless to humans. However, calcium and magnesium content in generally supplied hard water can be too high for pets, whose bodies are smaller than humans, potentially leading to formation of urinary calculi or stones.

Systems and methods for water softening have been developed primarily for generating high-quality drinking water for humans. In particular, conventional technologies in large scale systems to generate filtered water at the water source or complex devices including filter-regenerating functions. In view of the lack of developments targeted for use for dogs, cats and other small animals, this document provides a water softening device, which is portable, easy to handle and specifically tailored to generate soft water suitable for pets.

### BRIEF DESCRIPTION OF THE DRAWINGS

FIG. 1 illustrates a front perspective view of an example of a water softening ball according to an embodiment.

FIG. 2 illustrates a from perspective view of the shell when the upper and lower shells are detached from each other at substantially the equatorial circumference of the shell.

FIG. 3 illustrates an example of the filter unit.

FIG. 4 illustrates a cross-sectional view of the example of the water softening ball, illustrated in FIG. 1, across the plane including the equatorial circumference of the shell.

FIG. 5 illustrates an example configuration of the water softening ball in use.

### DETAILED DESCRIPTION

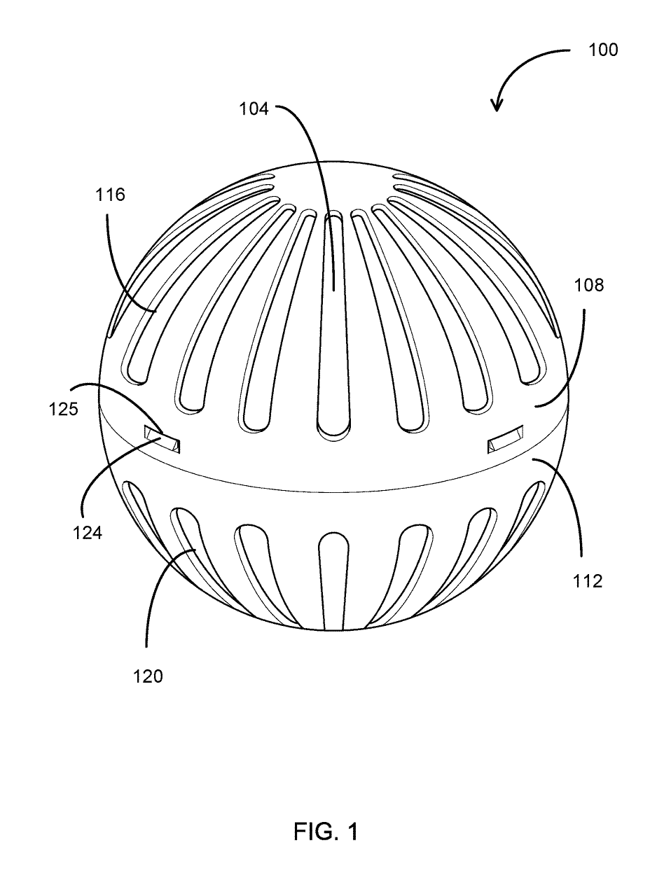

FIG. 1 illustrates a front perspective view of an example of a water softening ball according to an embodiment. In this example, the water softening ball 100 is illustrated to have a generally spherical shape; however, the shape can be ellipsoidal, elongated along a vertical axis or a horizontal axis. Generally, an ellipsoid is defined by semi-principal axes of length a, b and c; and a sphere is a special case of an ellipsoid in which a=b=c. Thus, it should be understood by one of ordinary skill in the art that an ellipsoidal shape includes a spherical shape. The water softening ball 100 comprises a shell having a generally hollow ellipsoidal shape and a filter unit 104 included within the shell. The filter unit 104 comprises an ion exchange resin for softening water according to an embodiment. The shell comprises a first shell and a second shell coupled to each other. These first and second shells correspond to an upper shell 108 and a lower shell 112, respectively or vice versa, in the example illustrated in FIG. 1. A plurality of openings are formed in the shell, allowing the inside and outside of the shell to communicate. A first plurality of openings 116 are formed in the upper shell 108, and a second plurality of openings 120 are formed in the lower sell 112. The shape of each opening can be oval, rectangular, polygonal or other shape, and can be straight, bent, tapered, zigzag, meshed or other form, as long as channeling of water between the inside and the outside of the shell 200 is promoted through the openings. The shell 200 may be made of a plastic, for example.

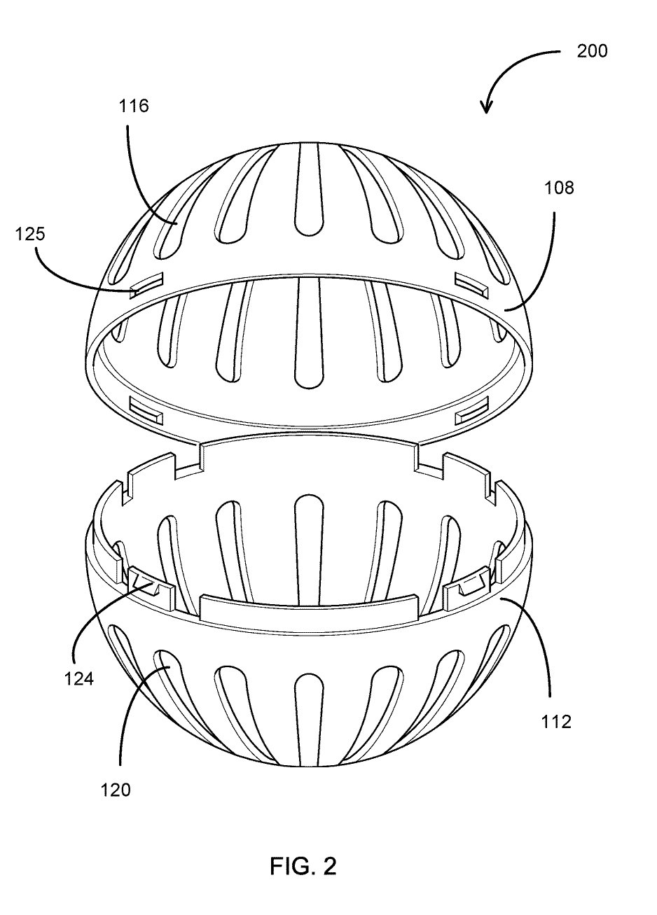

FIG. 2 illustrates a front perspective view of the shell 200 when the upper shell 108 and the lower shell 112 are detached from each other at substantially the equatorial circumference of the shell 200. Each of the upper and lower shells 108 and 112 has a generally hollow semi-ellipsoidal shape in this example, having an opening defined by an elliptical edge. Here, an ellipse includes a circle, as an ellipsoid includes a sphere, as mentioned earlier. In this example, the volumes of the upper and lower shells 108 and 112 are illustrated to be substantially the same. Instead of at substantially the equatorial circumference of the shell 200, the upper and lower shells 108 and 112 may be configured to be attached to and detached from each other at an off-equatorial circumference of the shell 200. Thus, the volumes of the upper and lower shells 108 and 112 can be different, whereby each of the upper and lower shells 108 and 112 has a generally hollow partial ellipsoidal shape with an opening defined by an elliptical edge. For example, one of the upper and lowers shells 108 and 112 may be configured to be a small part of the shell 200, providing a small hole in the shell 200 when the part is detached.

The upper and lower shells 108 and 112 may be configured to be attached to and detached from each other by means of fasteners including hooks, screws, pins, latches and other engaging mechanism. In the example illustrated in FIGS. 1 and 2, a plurality of latching tabs 124 are formed at the elliptical edge portion of the lower shell 112, and a plurality of latching slits 125 are correspondingly formed at the elliptical edge portion of the upper shell 108, providing means for attaching and detaching the upper and lower shells 108 and 112 by engaging and disengaging, respectively, the latching tabs 124 and the corresponding latching slits 125. By using the engaging mechanism, the upper and lower shells 108 and 112 can be attached to and detached from each other, thereby enabling a user, a manufacturer, a retailer or any relevant person to replace the ion exchange resin inside the shell 200. Alternatively, the upper and lower shells 108 and 112 may be configured to be non-detachably attached to each other once the ion exchange resin is included within the shell 200. In this case, the replacement of the ion exchange resin is carried out by replacing the entire ball 100.

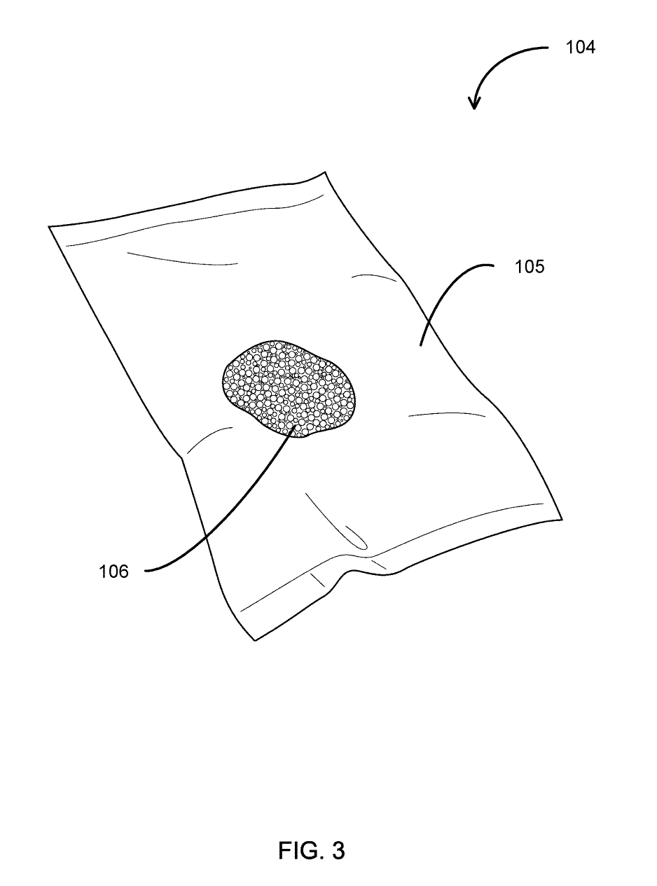

FIG. 3 illustrates an example of the filter unit 104. The filter unit 104 comprises a bag 105 and an ion exchange resin 106 contained therein. The bag 105 may be made of a nonwoven fabric. In this figure, part of the bag 105 is illustrated to be open or transparent to show the content, which is the iron exchange resin 106 in the form of beads. Thus, the entire filter unit 104 is deformable to fit in an ellipsoidal, spherical, cuboidal or other shaped shell. In the case where the upper and lower shells 108 and 112 are configured to be detachably attached to each other, it is easy to replace the entire filter unit 104, comprising the bag 105 and the ion exchange resin 106 contained therein, to replace the ion exchange resin 106.

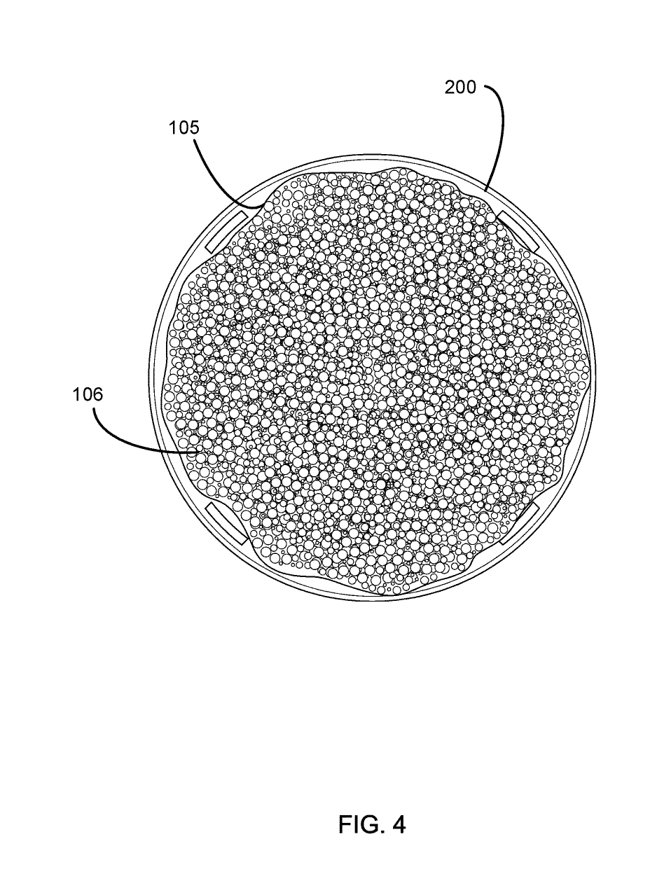

FIG. 4 illustrates a cross-sectional view of the example of the water softening ball 100, illustrated in FIG. 1, across the plane including the equatorial circumference of the shell 200. The shell 200 contains the filter unit 104 comprising the bag 105 and the iron exchange resin 106 contained therein. The internal volume of the shell 200 is optimized to be stuffed with the entire filter unit 104, which contains a predetermined amount of the ion exchange resin 106.

Another example of the filter unit 104 may comprise a layer having a generally hollow ellipsoidal shape configured to cover the internal surface of the generally hollow ellipsoidal shape of the shell 200, and an ion exchange resin in the form of beads contained inside the layer. The layer may be made of a nonwoven fabric, and attached to the internal surface of the shell 200 by using an adhesive or other means. Part of the shell, together with the layer covering the internal surface thereof, may be configured to be detachably attached to the rest of the shell so that the part can be detached when the ion exchange resin needs to be replaced. Alternatively, the part of the shell, together with the layer covering the internal surface thereof, may be configured to be non-detachably attached to the rest of the shell once the ion exchange resin is included within the layer and the shell, in this case the replacement of the ion exchange resin is carried out by replacing the entire ball 100.

Yet another example of the filter unit 104 may comprise an ion exchange resin in the form of beads without having a bag, such as the bag 105, or a layer covering the internal surface of the hollow ellipsoidal shape of the shell 200, as in the above example. In this case, the dimensions of each of the openings 116 and 120 need to be configured to prevent any of the beads from leaking out. The diameter of a bead of a typical ion exchange resin nowadays is about 0.5 mm -1 mm. Thus, at least one dimension of each opening should be made less than 0.5 mm to prevent the leak. For example, the shell 200 may be configured to form a fine mesh with at least one dimension of each opening being less than 0.5 mm. Part of the meshed shell may be configured to be detachably attached to the rest of the shell so that the part can be detached when the ion exchange resin needs to be replaced. Alternatively, the part of the meshed shell may be configured to be non-detachably attached to the rest of the shell once the ion exchange resin is included within the shell. In this case, the replacement of the ion exchange resin is carried out by replacing the entire ball 100.

Ion exchange resins are typically polymers that are capable of exchanging particular ions within the polymer with ions in a solution that come in contact with them. In water softening applications, Na⁺-based or H⁺-based ion exchange resins are typically used to reduce the mineral content, in particular, the magnesium and calcium ions, found in hard water. For the case of a Na⁺-based ion exchange resin, when the resin is fresh, it contains sodium ions at its active sites. As the water passes through the resin, the resin takes up magnesium and calcium ions to its active sites, and releases Na⁺ ions in the water, thereby softening the water. The resin can be recharged by washing it with salt water. The similar ion exchange mechanism can be carried out by using an H⁺-based ion exchange resin, except that an H⁺-based ion exchange resin is typically not rechargeable. The ion exchange resin in the filter unit 104 may be Na⁺-based or H⁺-based. However, it is preferable to use H⁺-based ion exchange resin for drinking water. This is because the released Na⁺ ions in the water inevitably increases the Na⁺ ion content, thereby making it less suitable for drinking water for a pet. By using an H⁺-based ion exchange resin, H⁺ions get released in the water in exchange of the minerals including magnesium and calcium ions. H⁺ions are generally harmless for a pet.

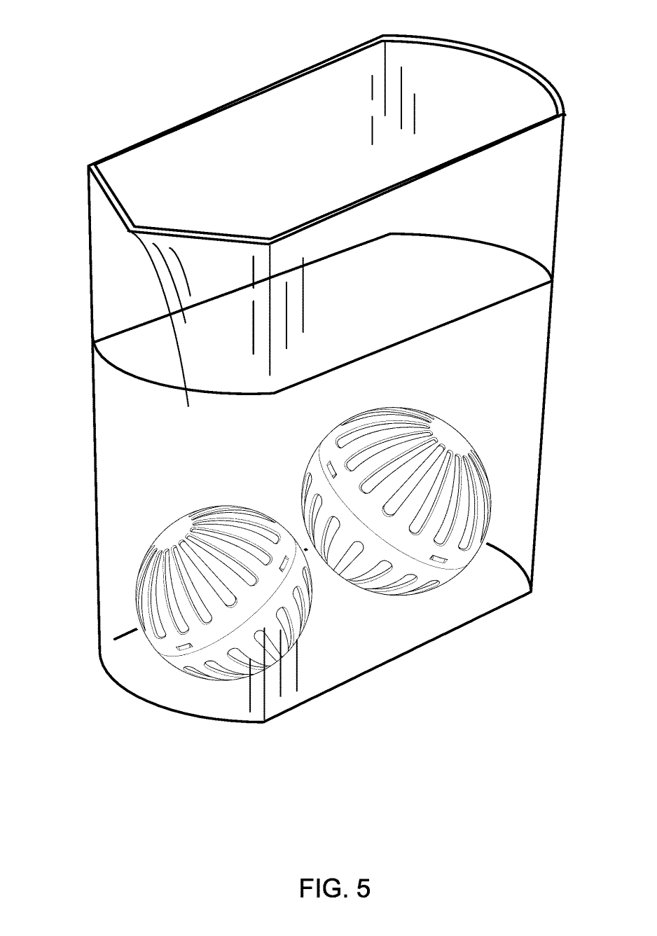

FIG. 5 illustrates an example configuration of the water softening ball 100 in use. One or more balls can be put in original water, which may be tap water or already filtered and/or softened water to some degree. The water enters the ball 100 through the plurality of openings 116 and 120 formed in the shell 200, and then enters the filter unit 104, thereby contacting the ion exchange resin 106. The water that has contacted the ion exchange resin 106 can exit the shell 200 through the plurality of openings 116 and 120. It may be necessary to shake the container including the water and the one or more balls 100 to promote contacting of the water with the ion exchange resin 106 in the form of beads. The number of the balls can be adjusted depending on the level of water softening desired with respect to the water hardness of the original water. In a region where the tap water hardness is high, two or more balls may be required. Alternatively, a commercially available water softening or filtering device may be used primarily, and the softened or filtered water may be further softened by adding one or more of the water softening ball 100.

Water hardness is measure of the concentration of mineral content, in particular, Ca²⁺ and Mg²⁺ ions in water, which can be readily measured by using an off-the-shelf measurement device. In general, water hardness is expressed in various units, such as a molar concentration, ppm, mg/L, etc. The unit of mg/L is used herein, where L=liter=1000 cm³. Water hardness of tap water differs from region to region; for example, it is about 30 in New York, 55 in San Francisco and in most areas of Japan, 90 in Los Angeles, 130 in Chicago, and 300 in Las Vegas and San Diego. The amount of ion exchange resin in the form of beads included in the present water softening ball can be predetermined in relation to the amount of water to be softened and the degree of softness to be achieved. Empirical relationships among relevant parameter values are explained below. Although specific numbers are cited herein to explain such relationships and metrics as examples, it should be understood that these are approximate values. The water softening rate, i.e., the hardness reduction, is 100% when the original water hardness of 50 is reduced to 0, and it is 50% when the original water hardness of 50 is reduced to 25. Obviously, there is a trade-off relationship between the amount water that can be softened and the degree of hardness reduction. Table 1 below lists examples showing the relationships between the amount of water that can be softened and the degree of hardness reduction by using different amounts of the ion exchange resin.

TABLE 1

| | | | | Water | Number of |
|---|---|---|---|---|---|
| | | | Hardness | Softened | Days with |
| | | | Reduction | (L) × | Drinking |
| Iron | Water | Hardness | (Water | Hardness | Rate of |
| Exchange | Softened | Reduction | Softening | Reduction | 0.5 L |
| Resin (g) | (L) | (Δ) | Rate, %) | (Δ) | per Day |
| 100 | 100 | 50 → 0 | 100% | 5000 | 200 |
| 100 | 50 | 100 → 0 | 100% | 5000 | 100 |
| 100 | 60 | 100 → 20 | 80% | 5000 | 120 |
| 40 | 100 | 50 → 30 | 40% | 2000 | 200 |
| 40 | 80 | 50 → 25 | 50% | 2000 | 160 |
| 40 | 60 | 50 → 15 | 70% | 2000 | 120 |
| 40 | 50 | 50 → 10 | 80% | 2000 | 100 |
| 40 | 40 | 50 → 0 | 100% | 2000 | 80 |
| 40 | 40 | 100 → 50 | 50% | 2000 | 80 |
| 40 | 30 | 100 → 30 | 70% | 2000 | 60 |
| 40 | 25 | 100 → 20 | 80% | 2000 | 50 |
| 40 | 10 | 300→ 90 | 70% | 2000 | 70 |

As exemplified in Table 1, for the case of a typical ion exchange resin in the form of beads, 100 g of it can reduce the hardness of 100 L of water, which originally had the hardness of 50, to zero; and 100 g of it can reduce the hardness of 50 L of water, which originally had the hardness of 100, to zero. These are the cases for the water softening rate of 100%. By using 40 g of the ion exchange resin with the water softening rate of 100%, the hardness of 40 L of water, which originally had the hardness of 50, can be reduced to 0. By using 40 g of the ion exchange resin, 80 L of water can be softened with the water softening rate of 50% (reduction of the hardness from 50 to 25, for example). Similarly, by using 40 g of the ion exchange resin, about 60 L of water can be softened with the water softening rate of 70% reduction of the hardness from 50 to 15, for example). Typically, a dog, a cat or other small animal needs about 0.5 L of water per day; thus, 60 L of the soft water (reduced from 50 to 15, for example) gets consumed after 120 days, and 80 L of the soft water (reduced from 50 to 25, for example) gets consumed after 160 days. The rightmost column in Table 1 lists the number of days it takes for the corresponding amount of softened water to be consumed, assuming that the pet drinks 0.5 L per day.

Experiments suggested that excessive removal of the mineral content can degrade the taste and flavor of the water, and may even cause mineral deficiency. Thus, the hardness reduction, i.e., the water softening rate, should not be excessive, and yet the concentration of Ca²⁺ and Mg²⁺ ions should be reduced to a healthy level. Numerous experiments suggested that the concentration level of the Ca²⁺ and Mg²⁺ ions, which can maintain a small animal healthy (e.g., preventing, urinary calculi or stones) and yet keep the taste and flavor of the water, corresponds to the water hardness level in the range of 10-30. This range corresponds to the water softening rate of roughly 40-80% for the water with the original hardness of 50 by using 40 g of the ion exchange resin. The empirical relationships, shown in bold face in Table 1, suggest that 40 g of the ion exchange resin can soften 50-100L of water from the hardness level of 50 to the level in the range of 10-30, which lasts for 100-200 days, assuming that the pet drinks 0.5 L of the water per day. In the case when the water hardness level is reduced from 100 to 30, 40 g of the ion exchange resin can soften 30 L of water, which lasts for 60 days. Thus, the frequency of replacing the ion exchange resin is once in 2-7 months, which is a desirably long interval. On the other hand, a human needs about 2 L of water per day; thus, 50 L of softened water lasts for 25 days, whereby the frequency of replacing the ion exchange resin is less than a month, which may be relatively frequent and costly.

In the present water softening ball 100, the amount of ion exchange resin in the filter unit 104 and the volume of the shell 200 are optimized for generating drinking water soft enough for a pet such as a dog, a cat and other small animal, and yet keeping the original taste and flavor. The volume of the shell 200 is configured to be small enough to be put in a container or a pitcher with a capacity of water that can be handled with one hand. A small animal for a pet typically drinks about 0.5 L of water per day. Certain types of small cats drink even less, such as 0.2 L per day. Accordingly, the volume of the shell 200 is configured to be small enough, to be put in a container having a capacity of at least the daily amount of drinking water for a pet. That is, the diameter or one dimension of the shell 200 may be in the range of 3 cm -6 cm, so that it can be easily accommodated in a container having a capacity in the range of 0.25 L-1.5 L. Here, a measure of the diameter is for the case wherein the shell 200 has a generally spherical shape, and a measure of the one dimension may be twice the length of one of the three semi-principal axes, i.e., 2a, 2b or 2c, for the case wherein the shell has a generally ellipsoidal shape. Correspondingly, the amount of the ion exchange resin may be in the range of 20 g -70 g, Therefore, the present water softening ball is configured as above based on the optimization considerations to generate softened water for a pet, such as a cat, a dog and other small animal.

It should be noted that in the regions where the water hardness is high, for example, 120 or higher, it takes more resin to lower the hardness to a desired level, and/or the resin needs to be replaced frequently. For example, by using 40 g of the ion exchange resin, only 10 L of water can be softened from the hardness level of 300 to 90, as exemplified in Table 1, giving about 20 day supply of soft water for a pet it should be noted that the ion exchange resin itself may not be capable of drastically reducing the water hardness. In the above example, the hardness reduction from 300 to 90 corresponds to the softening rate of 70%, but the resultant water is still as hard as 90. This means, in a region having the water hardness of 300, such as Las Vegas or San Diego, even by using the ion exchange resin with the water softening rate of 80%, the resultant hardness is still 60, which is not suitable for a pet. Thus, one water softening ball 100 configured and optimized for a pet as above may be suitable for use in regions where the water hardness is less than 120. Alternatively, the water softening device disclosed in the commonly-owned U.S. patent application Ser. No. 14/990,081 may be suitable for use in such regions. The entire disclosure of the above U.S. patent application is incorporated herein by reference. In regions where the water hardness is 120 or higher, two or more balls can be used to soften the original water. Alternatively, one or more balls may be added to the water contained in the above mentioned water softening device to further reduce the water hardness, wherein the water can be water contained for processing or water contained after processing in the water softening device.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

What is claimed is:

1. A water softening hall for use for a pet comprising:
a shell having a generally hollow ellipsoidal shape, wherein a plurality of openings are formed in the shell for an inside and an outside of the shell to communicate; and
a filter unit included within the shell and comprising an ion exchange resin.

2. The water softening ball of claim 1, wherein
the shell comprises a first shell and a second shell, each of which has a generally hollow partial ellipsoidal shape having an opening defined by an elliptical edge.

3. The water softening ball of claim 2, wherein
the first and second shells are detachably attached to each other based on an engaging mechanism.

4. The water softening ball of claim 3, wherein
the engaging mechanism is based on a plurality of latching tabs formed at the elliptical edge portion of the first shell and a plurality of latching slits correspondingly formed at the elliptical edge portion of the second shell.

5. The water softening ball of claim 1, wherein
the first and second shells are non-detachably attached to each other once the ion exchange resin is included within the shell.

6. The water softening ball of claim 1, wherein
the filter unit further comprises a bag made of a nonwoven fabric, which contains the ion exchange resin therein.

7. The water softening ball of claim 1, wherein
the filter unit further comprises a layer made of a nonwoven fabric having a generally hollow ellipsoidal shape and configured to cover an internal surface of the generally hollow ellipsoidal shape of the shell, the layer containing the ion exchange resin therein.

8. The water softening ball of claim 1, wherein
the plurality of openings are formed in the shell to configure a meshed shell, wherein at least one dimension of each of the plurality of openings is configured to be smaller than a diameter of a head of the ion exchange resin.

9. The water softening ball of claim 1, wherein
an amount of the ion exchange resin and a volume of the shell are optimized for generating softened water for a pet including a dog, a cat and other small animal by putting the water softening ball in original water.

10. The water softening ball of claim 9, wherein
water hardness of the softened water generated for a pet is in the range of 10 mg/L-30 mg/L, wherein the water hardness is a measure of a concentration of mineral content including Ca²⁺ and Mg²⁺ ions in water.

11. The water softening ball of claim 9, wherein
one or more of the water softening balls are used to generate the softened water, wherein the number of the water softening balls is adjusted depending on water hardness of the original water.

12. The water softening ball of claim 9, wherein
a diameter or one dimension of the shell is in the range of 3 cm-6 cm.

13. The water softening ball of claim 9, wherein
the amount of the ion exchange resin is in the range of 20 g-70 g.

14. The water softening ball of claim 1, wherein
the ion exchange resin is an H⁺-based ion exchange resin.
